(19) United States
(12) Patent Application Publication
(10) Pub. No.: US 2003/0130993 A1
(43) Pub. Date: Jul. 10, 2003

(54) Document categorization engine

(75) Inventors: Ofer Mendelevitch, Brisbane, CA (US); Andrew Feit, Cupertino, CA (US); Christina Kindwall, San Francisco, CA (US); Benjy Weinberger, San Mateo, CA (US); Wendy Wilson, Los Altos Hills, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Quiver, Inc., San Mateo, CA

(21) Appl. No.: 10/216,560

(22) Filed: Aug. 8, 2002

Related U.S. Application Data
(60) Provisional application No. 60/311,029, filed on Aug. 8, 2001.

(51) Int. Cl. G06F 7/00

(52) U.S. Cl. 707/3

(57) ABSTRACT

Automatic classification is applied in two stages: classification and ranking. In the first stage, a categorization engine classifies incoming documents to topics. A document may be classified to a single topic or multiple topics or no topics. For each topic, a raw score is generated for a document and that raw score is used to determine whether the document should be at least preliminarily classified to the topic. In the second stage, for each document assigned to a topic (i.e., for each document-topic association) the categorization engine generates confidence scores expressing how confident the algorithm is in this assignment. The confidence score of the assigned document is compared to the topic's (configurable) threshold. If the confidence score is higher than this configurable threshold, the document is placed in the topic's Published list. If not, the document is placed in the topic's Proposed list, where it awaits approval by a knowledge management expert. By modifying a topic's threshold, a knowledge management expert can advantageously control the tradeoff between human oversight and control vs. time and human effort expended.

### CROSS-REFERENCES TO RELATED APPLICATIONS

This application claims the benefit of U.S. Provisional Patent Application Serial No. 60/311,029, (atty docket 020302-001900US), entitled “Document Categorization Engine”, filed Aug. 8, 2001, the contents of which are hereby incorporated by reference in its entirety.

### BACKGROUND OF THE INVENTION

The present invention relates to document categorization, and more particularly to systems and methods for classifying documents to a database and for efficiently managing the document database.

One problem of document classification is that of assigning documents to one or more predefined topics. These topics are usually arranged in a taxonomy structure. In large enterprises for example, document classification solutions may be required to operate on the scale of thousands of topics and millions of documents.

Traditionally, there have been two methods used for document classification: fully manual and fully automated. Manual classification offers accuracy and control but lacks scalability and efficiency. Automatic classification offers scalability and efficiency but lacks accuracy and control.

Manual classification requires a human information expert to select the topic or topics to which each document belongs. This method offers pinpoint accuracy and complete human oversight and control, but is intensive in its use of time and labor and therefore lacks efficiency and scalability. Dedicated software workflow solutions may improve the productivity of information specialists and allow their work to be distributed among different experts within various knowledge sub-domains. However the human decision-making process means that classification at the enterprise scale requires a dedicated knowledge management group of formidable size.

Automated classification involves the use of various algorithms to automatically assign documents to topics. These algorithms are usually “trained” on a small document subset (the training set) used to represent typical documents in each topic. The trained algorithm is then applied to the unclassified documents. One problem with such methods is that the accuracy on real-world data is generally not sufficiently high. Such algorithms typically achieve up to 75-80% accuracy on relatively idealized sample sets, while real-world results are usually poorer. Fully automatic systems are therefore fraught with errors and these systems lack the tools to allow human intervention to correct the errors.

Accordingly, it is therefore desirable to provide document categorization systems and methods that provide a classification solution that is both scalable and accurate.

### BRIEF SUMMARY OF THE INVENTION

The present invention provides document categorization systems and methods that are both scalable and accurate by combining the efficiency of technology with the accuracy of human judgment. The categorization systems and methods of the present invention use classification and ranking algorithms to achieve the best possible automatic classification results. However, as opposed to fully automatic systems, these results are not treated as definitive. Instead, these results are incorporated into a full-featured manual workflow system, allowing enterprise knowledge experts as much, or as little, oversight and control as they require.

The manual workflow system of the present invention provides an advanced, intuitive user interface (UI) for managing taxonomy construction and manual classification or reclassification of documents to topics. Different parts of the topic taxonomy can be assigned to different users to allow for distributed human control. The workflow U1 provides a highly advanced environment for manual classification and taxonomy construction and is a valuable tool for these purposes even without application of automatic classification aspects.

In one aspect of the workflow UI, each topic contains three lists of documents. For example, a topic's Published list contains the documents that have been definitively assigned to the topic. A topic's Proposed list contains the documents that have been suggested as candidates for inclusion in the topic's Published list, but have not yet been definitively assigned to the topic. A topic's Training list contains examples of typical documents for that topic, used to train the automatic classification algorithms.

Using the manual workflow system, for example, junior information managers or general users can place documents in a topic's Proposed list where they will await approval by senior information specialists with the authority to assign the document to the topic's published list.

According to the present invention, automatic classification is preferably applied in two stages: classification and ranking. In the first stage, a categorization engine (e.g., algorithm) executes in the background (after being trained), classifying incoming documents to topics. A document may be classified to a single topic or multiple topics or no topics. For each topic, a raw score is generated for a document and that raw score is used to determine whether the document should be at least preliminarily classified to the topic. For example, a match for one or several features or set(s) of keywords will indicate that the document should be classified to a certain topic. However, the raw score generally does not indicate how well a document matches a topic, only that there is some discernable match. In the second stage, for each document assigned to a topic (i.e., for each document-topic association) the categorization engine generates confidence scores expressing how confident the algorithm is in this assignment. Once the categorization engine has assigned a document to a topic and generated a confidence score, the confidence score of the assigned document is compared to the topic's (configurable) Autopublish threshold. If the confidence score is higher than this configurable threshold, the document is placed in the topic's Published list. If the confidence score is lower than the Autopublish threshold, the document is placed in the topic's Proposed list, where it awaits approval by a knowledge management expert (i.e., a user). By modifying a topic's Autopublish threshold, a knowledge management expert responsible for that topic can control the tradeoff between human oversight and control vs. time and human effort expended. The higher the threshold, the more documents placed into the Proposed list and the greater the human effort required to examine them. The lower the threshold, the more documents placed directly into the Published list and the smaller the effort required to manually approve the automatic classification decisions, although inevitably with less accurate results.

According to an aspect of the invention, a method is provided for classifying documents to one or more topics. The method typically includes receiving a set of one or more documents, automatically applying a classification algorithm to each document so as to associate each document with none, one or a plurality of the topics, and for each document-topic association, automatically determining a confidence score, and comparing the confidence score to a user-configurable threshold. The method also typically includes associating the document with a first list for the topic if the confidence score exceeds the threshold, and associating the document with a second list for the topic if the confidence score does not exceed the threshold. The method also typically includes, for a selected topic, providing the second list of documents to a user for manual confirmation or re-classification.

According to another aspect of the invention, a system is provided for classifying documents to one or more topics. The system typically includes a processor for executing a document categorization application. The categorization application typically includes a communication module configured to receive a plurality of documents from one or more sources, a classification module configured to automatically apply a classification algorithm to each document so as to associate each document with none, one or more of the topics, and a ranking module configured to, for each document-topic association, automatically determine a confidence score and compare the confidence score to a user configurable threshold. The system also typically includes a data base memory configured to store two lists for each topic, wherein for each document-topic association, if the confidence score exceeds the threshold, the document is stored to a first list associated with the topic, and if the confidence score does not exceed the threshold, the document is stored to a second list associated with the topic. The system also typically includes a means for displaying the second list of documents for a selected topic to a user for manual confirmation or reclassification.

According to yet another aspect of the present invention, a computer-readable medium including computer code for controlling a processor to classify a document to one or more topics is provided. The code typically includes instructions to identify a set of one or more documents, to automatically apply a classification algorithm to each document in the set of documents so as to associate each document with none, one or a plurality of the topics, and for each document-topic association, to automatically determine a confidence score, to compare the confidence score to a user-configurable threshold, and to associate the document with a first list for the topic if the confidence score exceeds the threshold, and associate the document with a second list for the topic if the confidence score does not exceed the threshold. The code also typically includes instructions to render the second list of documents, for a selected topic, on a user display for manual confirmation or reclassification.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

FIG. 1 illustrates a client computer system configured with a document categorization application according to the present invention.

FIG. 2 illustrates a network arrangement for executing a shared application and/or communicating data and commands between multiple computing systems according to another embodiment of the present invention.

FIG. 3 illustrates an exemplary window displayed when an administrative tools option is selected according to one embodiment.

FIG. 4 illustrates an exemplary window displayed when a taxonomy management option is selected according to one embodiment.

FIG. 5 illustrates an exemplary window displayed when a user management option is selected according to one embodiment.

FIG. 6 illustrates an exemplary window displayed when a system management option is selected according to one embodiment.

FIG. 7 illustrates an exemplary window displayed when a recategorization option is selected according to one embodiment.

FIG. 8 illustrates an exemplary window displayed when an expired documents option is selected according to one embodiment.

FIG. 9 illustrates an exemplary window displayed when an E-mail notifications option is selected according to one embodiment.

FIG. 10 illustrates an exemplary window displayed when a back end processes option is selected according to one embodiment.

FIG. 11 illustrates an exemplary window displayed when a spider option is selected according to one embodiment.

FIG. 12 illustrates an exemplary window displayed when an import/export taxonomy option is selected according to one embodiment.

FIG. 13 illustrates an exemplary window displayed when a reports/logs option is selected according to one embodiment.

FIG. 14 illustrates an exemplary window displayed when a edit draft option is selected according to one embodiment.

FIG. 15 illustrates another view of the window of FIG. 14 after a user has selected a document list from the taxonomy tree according to one embodiment.

FIG. 16 illustrates another view of the window of FIG. 14 after a user has selected a document list from the taxonomy tree according to one embodiment.

FIG. 17 illustrates another view of the window of FIG. 14 after a user has selected a document list from the taxonomy tree according to one embodiment.

FIG. 18 illustrates an exemplary window displayed when a user selects an Advanced Topic Settings Option according to one embodiment.

FIG. 19 illustrates an example of a search window displayed to the user, for example in response to a search selection, according to one embodiment.

FIG. 20 illustrates an exemplary window displayed when view published option is selected according to one embodiment.

FIG. 21 illustrates an exemplary window displayed when aTopic Advisor option is selected according to one embodiment.

FIG. 22 illustrates an example of a Topic Advisor result window displayed in response to a Topic Advisor run according to one embodiment.

FIG. 23 illustrates an exemplary window displayed when an Information Manager Dashboard option is selected according to one embodiment.

### DETAILED DESCRIPTION OF THE INVENTION

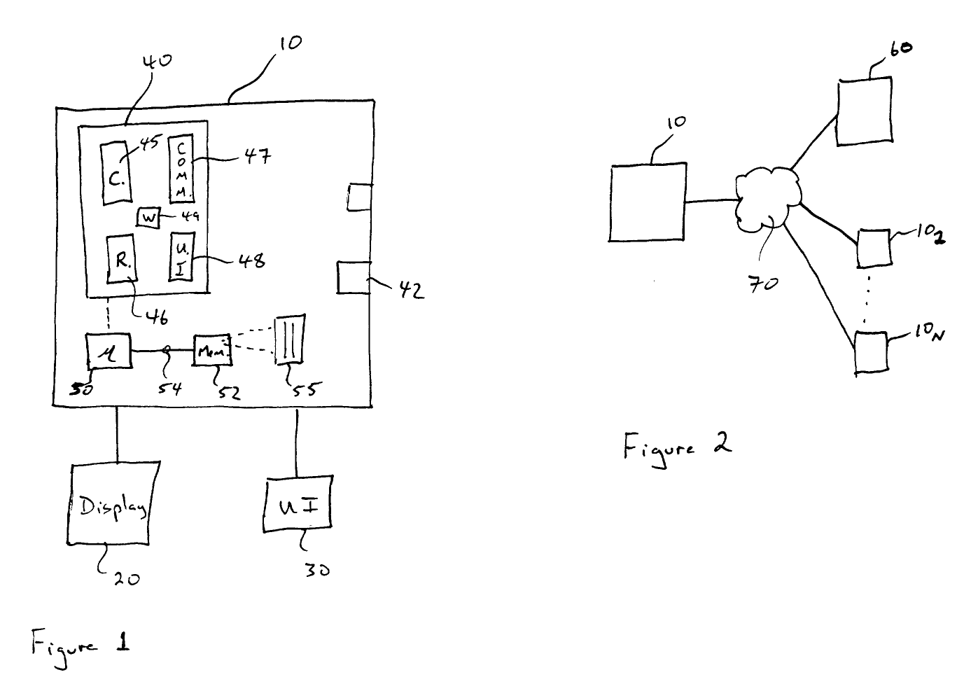

FIG. 1 illustrates a client computer system 10 configured with a document classification and categorization application module 40 (also referred to herein as “classification engine” or “categorization engine”) according to the present invention. FIG. 2 illustrates a network arrangement for executing a shared application and/or communicating data and commands between multiple computing systems according to another embodiment of the present invention. Client system 10 may operate as a stand-alone system or it may be connected to server 60 and/or other client systems 10 over a network 70.

Several elements in the system shown in FIGS. 1 and 2 include conventional, well-known elements that need not be explained in detail here. For example, a client system 10 could include a desktop personal computer, workstation, laptop, or any other computing device capable of executing categorization application module 40. In client-server or networked embodiments, a client system 10 is configured to interface directly or indirectly with server 60, e.g., over a network 70, such as the Internet, or directly or indirectly with one or more other client systems 10 over network 70. Client system 10 typically runs a browsing program, such as Microsoft's Internet Explorer, Netscape Navigator, Opera or the like, allowing a user of client system 10 to access, process and view information and pages available to it from server system 60 or other server systems over Internet 70. Client system 10 also typically includes one or more user interface devices 30, such as a keyboard, a mouse, touchscreen, pen or the like, for interacting with a graphical user interface (GUI) provided on a display 20 (e.g., monitor screen, LCD display, etc.).

In one embodiment, application module 40 executes entirely on client system 10, however, in some embodiments the present invention is suitable for use in networked environments, e.g., client-server, peer-peer, or multi-computer networked environments where portions of code may be executed on different portions of the network system or where data and commands (e.g., Active X control commands) are exchanged. In network embodiments, interconnection via a LAN is preferred, however, it should be understood that other networks can be used, such as the Internet or any intranet, extranet, virtual private network (VPN), non-TCP/IP based network, LAN or WAN or the like.

According to one embodiment, client system 10 and some or all of its components are operator configurable using categorization application module 40, which includes computer code executable using a central processing unit 50 such as an Intel Pentium processor or the like coupled to other components over one or more busses 54 as is well known. Computer code including instructions for operating and configuring client system 10 to process documents and data content, classify and rank documents, and render GUI images as described herein is preferably stored on a hard disk, but the entire program code, or portions thereof, may also be stored in any other volatile or non-volatile memory medium or device as is well known, such as a ROM or RAM, or provided on any media capable of storing program code, such as a compact disk (CD) medium, digital versatile disk (DVD) medium, a floppy disk, and the like. An appropriate media drive 42 is provided for receiving and reading documents, data and code from such a computer-readable medium. Additionally, the entire program code of module 40, or portions thereof, or related commands such as Active X commands, may be transmitted and downloaded from a software source, e.g., from server system 60 to client system 10 or from another server system or computing device to client system 10 over the Internet as is well known, or transmitted over any other conventional network connection (e.g., extranet, VPN, LAN, etc.) using any communication medium and protocols (e.g., TCP/IP, HTTP, HTTPS, Ethernet, etc.) as are well known. It should be understood that computer code for implementing aspects of the present invention can be implemented in a variety of coding languages such as C, C++, Java, Visual Basic, and others, or any scripting language, such as VBScript, JavaScript, Perl or markup languages such as XML, that can be executed on client system 10 and/or in a client server or networked arrangement. In addition, a variety of languages can be used in the external and internal storage of data, e.g., raw classification scores, confidence scores and other information, according to aspects of the present invention.

According to one embodiment, document categorization application module 40 executing on client system 10 includes instructions for classifying and ranking documents, as well as providing user interface configuration capabilities as described herein. Application 40 is preferably downloaded and stored in a hard drive 52 (or other memory such as a local or attached RAM or ROM), although application module 40 can be provided on any software storage medium such as a floppy disk, CD, DVD, etc. as discussed above. In one embodiment, application module 40 includes various software modules for processing data content. A communication interface module 47 is provided for communicating text and data to a display driver for rendering images (e.g., GUI images) on display 20, and for communicating with another computer or server system in network embodiments. A user interface module 48 is provided for receiving user input signals from user input device 30. Communication interface module 47 preferably includes a browser application, which may be the same browser as the default browser configured on client system 10, or it may be different. Alternatively, interface module 47 includes the functionality to interface with a browser application executing on client 20.

Application module 40 also includes a classification module 45 including instructions to process documents to determine which topics they belong to, if any, and a ranking module 46 including instructions to determine confidence scores for each document-topic association as discussed herein. Compiled statistics (e.g., classification scores and confidence scores), documents attributes, data and other information are preferably stored in database 55, which may reside in memory 52, in a memory card or other memory or storage system, for retrieval by classification module 45 and ranking module 46. It should be appreciated that application module 40, or portions thereof, as well as appropriate data can be downloaded to and executed on client system 10.

In the client-server arrangement of FIG. 2, portions of module 40 may execute on client 10 while portions may execute on server 60 and/or on any other client 10₁-10_{N}.

In preferred aspects, application module 40 (or classification engine 40) processes documents in two stages: (i) classification (or sorting), and (ii) ranking. In the classification stage an algorithm is applied to determine, for each document, to which topic(s) in the taxonomy it belongs, if any. In the ranking stage, a confidence score (e.g., a number between 0 and 1) is calculated for each document-topic association. Categorization module 40 is preferably capable of processing and categorizing documents formatted in any text-based file type, including for example, HTML, XML, MS Office (e.g., Word, Excel, Powerpoint, etc.), Lotus suite and notes, PDF, and any other text-based file types. Non-text based file types may be managed by the system, using for example the Directory Management Toolset (DMT) features as will be discussed below. For example, non-text based file type documents such as JPEG, AVI, etc. formatted documents may be placed into topics for users to browse, however, these files are typically not processed using the categorization engine. In some aspects, voice-to-text applications may be used to convert portions of such files to text for processing by the categorization engine.

In certain aspects, when processing text-based file types, each document is preferably converted into a raw text stream. For a given document, each text object (e.g., term or word) is placed in a data structure, e.g., simple table, with an indication of the number of occurrences of that term. Preferably, certain “stop words” including, for example, “a”, “and”, “if”, and “the”, are not used. The data structure is used by the machine-learning algorithm(s) to determine whether the document should be placed in a topic. Because certain metadata may be highly pertinent to the classification process, the system advantageously allows the user to configure the system to process or reject certain metadata. For example, any tags, such as HTML tags, and other metadata may be stripped off during processing. Alternatively, a user may configure the system to process certain metadata such as, for example, tags or other metadata related to title information, or client-specific information such as client identifiers, or the language of words in a document, while font information may be dropped.

According to one embodiment, a two-stage automatic classification approach is utilized to classify documents into topics in the following manner:

1. Classification. Each document is fed into a machine-learning algorithm (such as Naive Bayes, Support Vector Machines, Decision Trees, and other algorithms as are well known); this algorithm determines a set of zero (0) or more topics from the taxonomy to which the document belongs.

2. Ranking. A confidence score is calculated for each document-topic association that was determined during classification. This confidence score provides a measure of the degree to which the document does in fact belong to that particular topic.

The classification architecture of the present invention is preferably binary such that a distinct classifier is built for each topic in the taxonomy. That is, for each topic, each document is processed by a machine-learning algorithm to determine whether the document satisfies a threshold criteria and should therefore be assigned to the topic. Each such classifier outputs for each document a “raw score” that in itself is a measure of the degree of confidence, but is not normalized across the classifiers, and therefore is preferably not used as an overall confidence score. Furthermore, it should be understood that different classifiers may use different machine-learning algorithms. As an example, the classifier for one topic may use a Naïve Bayes algorithm and the classifier for a second topic may use a Support Vector Machines algorithm.

In the ranking stage, ranking module 46 transforms raw scores into true confidence scores (e.g., a number between 0 and 1). In one embodiment, a confidence score is determined by first calculating four (4) distinct confidence measures, denoted CONF1, CONF2, CONF3 and CONF4, as follows:

CONF1(doc D, topic T) ranks all raw scores of a document across all topics. For a topic T, a document D is given a score proportional to the number of binary classifiers (each representing a single topic) wherein document D received a lower “raw score”.

CONF2(doc D, topic T) measures how the raw score for a document D ranks within the raw scores of all “negative” training documents (i.e., all training documents that are not in topic T).

CONF3(doc D, topic T) measures how the raw score for a document D ranks within the raw scores of all “positive” training documents (i.e., all training documents that were assigned to topic T).

CONF4(doc D, topic T) measures how the raw score for a document D ranks within the raw scores of all past documents the system has processed for the topic T.

These four confidence measures are then combined using a weighting scheme (e.g., different weights or the same weights) so as to calculate a final confidence score. Such weighting schemes may be adjusted via configuration parameters. In one embodiment, two different weighting schemes are used to produce two different confidence scores: one for internal thresholding use in the classification stage and the other to serve as the confidence score displayed to users. It should be appreciated that a subset of the four confidence measures, the four confidence measures, and/or additional or alternative confidence measures may also be used.

An optional Error-correcting-code classifier (ECOC) is provided in some embodiments to calculate confidence scores in a different manner. In such embodiments using ECOC, an output-error-correcting code matrix is calculated, and a binary classifier is created for each column of the coding matrix. A “raw score” is calculated for each document in each of the binary classifiers, and using “binning” a “binary classifier confidence score” is calculated for each such binary classifier. This score represents the confidence that a document belongs to the “positive” side of the binary classifier rather than to the negative side.

For binning in a given binary classifier, all the “raw scores” from all training documents (positive and negative) are processed during training so as to create “bins” of equal size and put the “raw scores” into those bins. Given a new document, the “raw score” is examined and placed in the appropriate bin; the “binary classifier confidence score” for that document is then the percentage of positive training documents that reside in that bin.

After binning, a “final” confidence score is calculated by combining the “binary classifier confidence scores” for all binary classifiers according to the coding matrix. According to one aspect, if a topic is in the positive side of a binary classifier, then that “binary confidence score” is preferably weighted as is, and if a topic is on the negative side of this classifier, then 1 minus the “binary confidence score” is used. This final single confidence score can be used both for classification and for display to users.

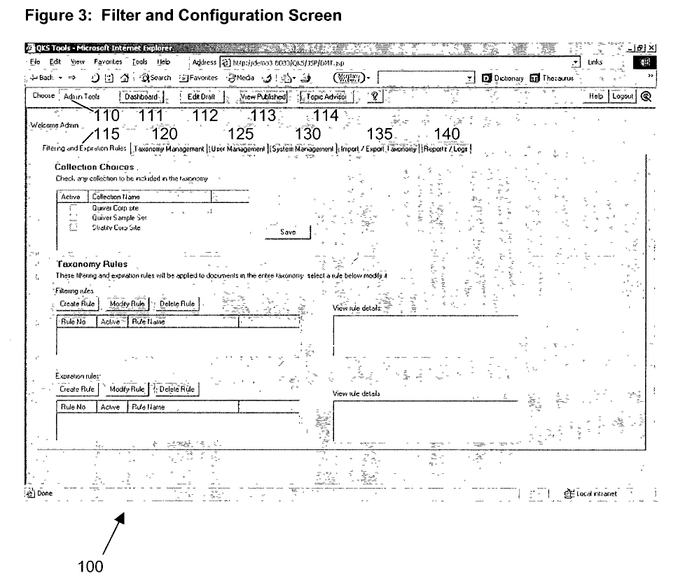

In one embodiment, a user interface toolset, termed herein the Directory Management Toolset (or DMT), is provided. In network embodiments, for example, application module 40 resident on client system 10 preferably implements the DMT, e.g., using a DMT module (not shown). In one embodiment, a DMT module includes four sub-modules: Administration Tools, Taxonomy Editing Tools, Topic Advisor and Information Manager Dashboard. These tools are integrated through various workflow methodologies. A graphical user interface representation is preferably displayed to users in a browser window. In network embodiments, the GUI is preferably implemented in part using ActiveX controls, e.g., received from a host system such as server 60. The user interface of the DMT in certain aspects is intuitive, and incorporates many MS Windows visual metaphors for ease of use and learning of the system. In certain aspects, the DMT employs a customizable “paned” approach. Preferably, all pertinent information can be viewed from a single browser. FIGS. 3-23 illustrate examples of various windows displayed to a user when using the DMT toolset as will be described below, wherein preferred functionality provided by the DMT will be discussed with reference to the tasks and functions a user may perform within each window or pane.

FIG. 3 illustrates an exemplary window 100 displayed when an administrative tools option 110 is selected according to one embodiment. As shown, multiple options are presented within the administrative tools selection 110: filtering and expiration rules option 115 (pane shown), taxonomy management option 120, user management option 125, system management option 130, import/export taxonomy option 135, and reports/logs option 140. Selection of filtering and expiration rules option 115, as shown, allows a user to select or define which documents or document collections (e.g., as selected or downloaded by a user or determined using a search spider product, such as an Inktomi Search product, or other search engine) will flow into the taxonomy structure. Option 115 also allows a user to define, view, modify, delete, activate and deactivate taxonomy-level filtering rules and taxonomy-level expiration rules.

It is preferred that a user is only able to access/view Admin tools tab 110 if they have Administrative level access, e.g., they are administrators of the system.

Preferably two taxonomies are included in the system: draft and published; information managers can make edits to the draft taxonomy and when done can publish revised draft taxonomy—this results in the published taxonomy.

Standard MS Office user interface metaphors are preferably implemented to facilitate quick understanding and minimize training needs. Such interface functionality includes, for example, the ability to drag and drop documents to and from topics within an application, from desktop and other sources; right click functions (e.g., screenshots); the use of tabs for navigation between tool functions; resizable panes; toolbar(s) featuring standard icons; taxonomy tree icons and navigation; tool tips and help; undo/redo last action buttons; and others as are well known.

In preferred aspects multiple user support functionality is provided, including for example, locking and releasing functionality and the ability to assign topics to specific users, e.g., for classification confirmation/checking. For example, in certain aspects, when a user begins making changes to a topic, the topic is automatically locked by that user and other users cannot make changes to the topic until the user has “released” the lock. Topics can be unlocked either by releasing them (does not publish changes) or publishing them. Additionally, in certain aspects, assigned topics are preferably distinguished from unassigned topics. For example, topics assigned to a user who is logged in may appear as yellow folders, and those topics not assigned to the user may appear as blue folders. This helps the user quickly identify which topics are assigned to him or her and allows the user to focus their energy accordingly.

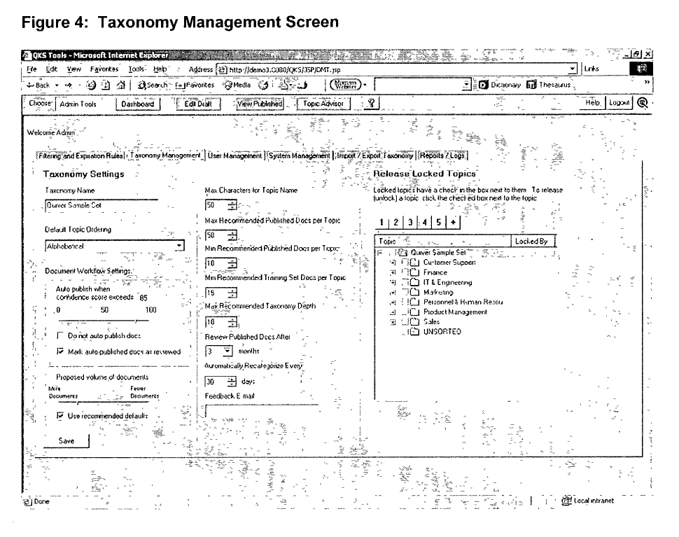

FIG. 4 illustrates an exemplary window displayed when taxonomy management option 120 of administrative tools window 110 is selected according to one embodiment. This window advantageously allows a user to perform many taxonomy management functions including, for example, defining and modifying taxonomy name(s), defining topic ordering (e.g., alphabetical or manual), viewing and modifying confidence scores for auto-publishing, viewing and modifying categorization precision and recall levels, setting alert levels for taxonomy management and Dashboard alerts, viewing and releasing topic locks, setting review cycle times, and defining and modifying feedback alias address(es).

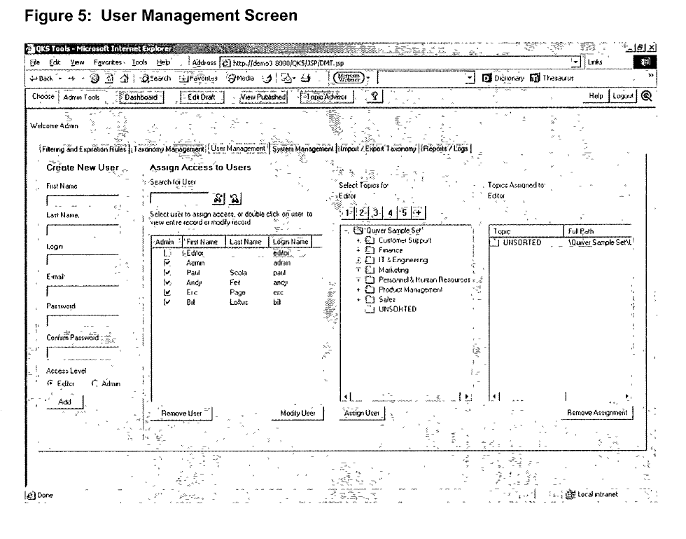

FIG. 5 illustrates an exemplary window displayed when user management option 125 of administrative tools window 110 is selected according to one embodiment. This window advantageously allows a user to perform many user management functions. For example, using this window, a user (e.g., preferably an administrator) is able to create, modify and delete users, search for existing users, change user access levels, assign users to topics (e.g., for manual review of classification results), view assigned topics for each user, add/remove assigned topics for each user, and view topics without assigned users.

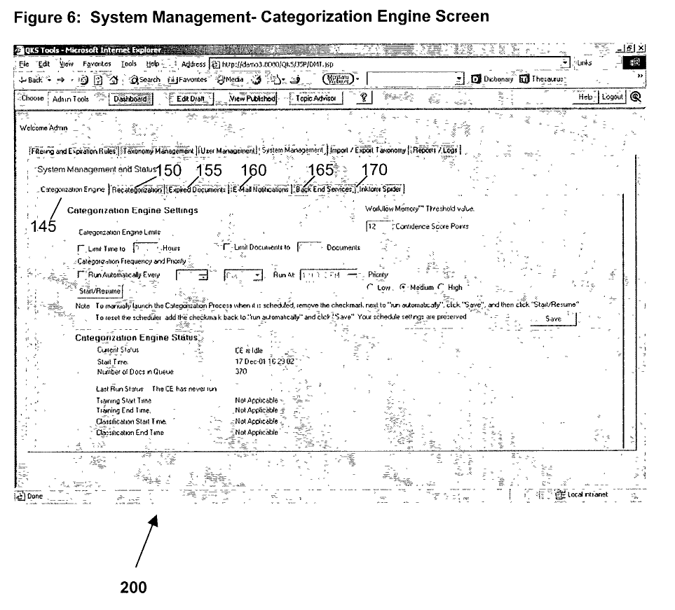

FIG. 6 illustrates an exemplary window 200 displayed when system management option 130 of administrative tools window 110 is selected according to one embodiment. This window advantageously allows a user to perform many system level management functions. As shown, additional options are provided, including categorization engine option 145 (selected), recategorization option 150, expired documents option 155, E-mail notifications option 160, back end services option 165 and spider option 170. Selection of categorization option 145, as shown, allows a user to define Categorization Engine runtime limits, set Workflow Memory (described below) thresholding values, set Categorization Engine run frequency, manually start and stop Categorization Engine runs, and view Categorization Engine (CE) status.

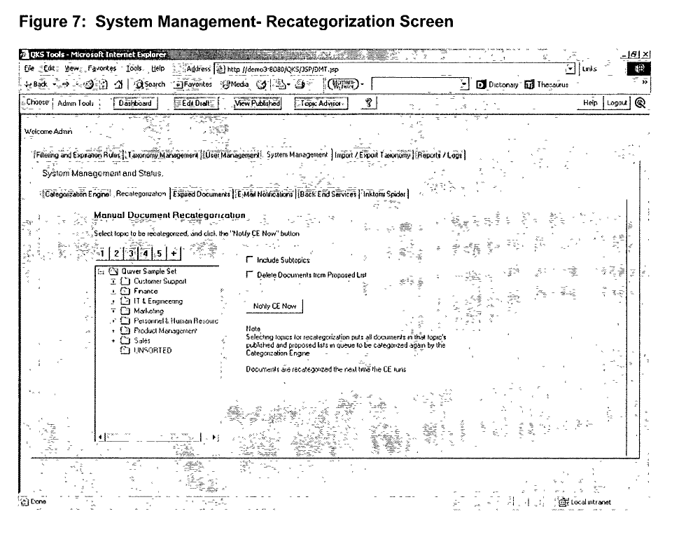

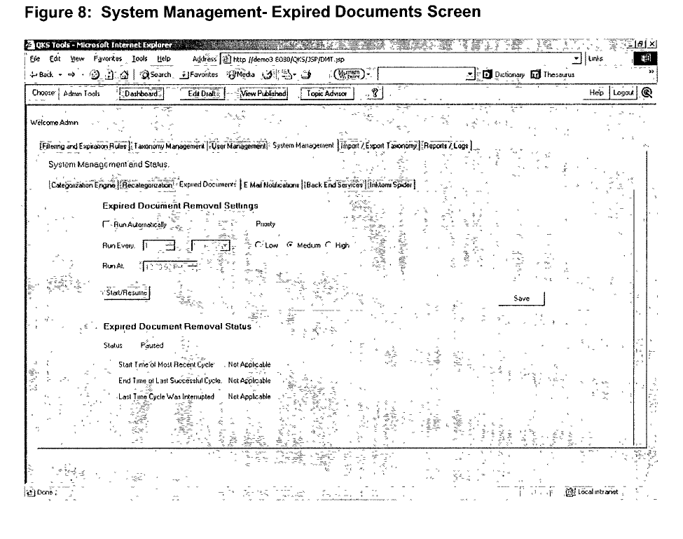

FIG. 7 illustrates an exemplary window displayed when recategorization option 150 of the system management window 200 is selected according to one embodiment. This window advantageously allows a user to recategorize one or more selected topics. For a topic selected for recategorization, the categorization engine preferably recategorizes all documents in the topic's published and proposed lists. FIG. 8 illustrates an exemplary window displayed when expired documents option 155 of the system management window 200 is selected according to one embodiment. This window allows the user to set parameters such as priority and frequency for removing documents that have expired, as well as view related status information.

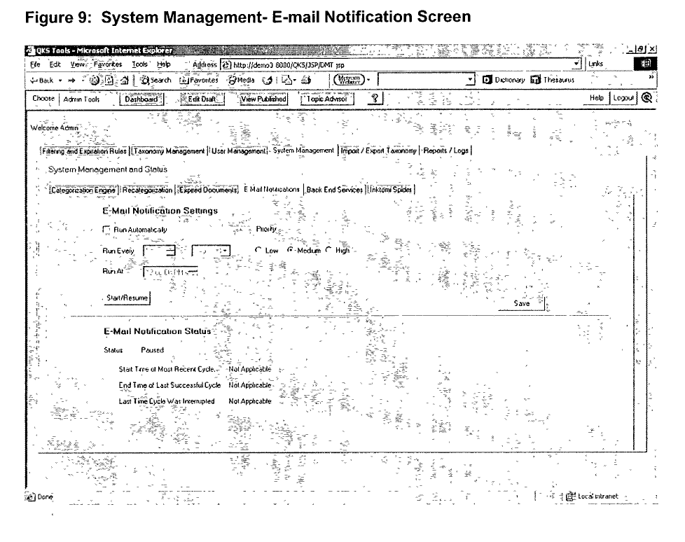

FIG. 9 illustrates an exemplary window displayed when E-mail notifications option 160 of the system management window 200 is selected according to one embodiment. This window allows the user to configure e-mail notification frequency for alerts.

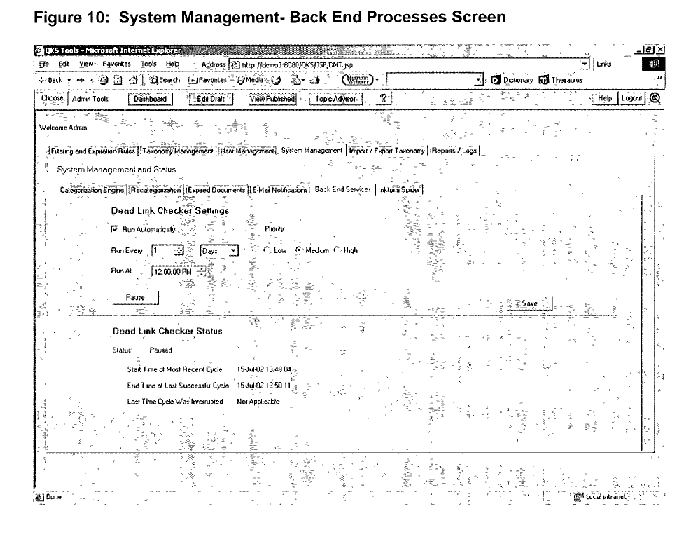

FIG. 10 illustrates an exemplary window displayed when back end processes option 165 of the system management window 200 is selected according to one embodiment. This window allows the user to define and view status of various back-end processes such as dead link checking for documents which are no longer accessible.

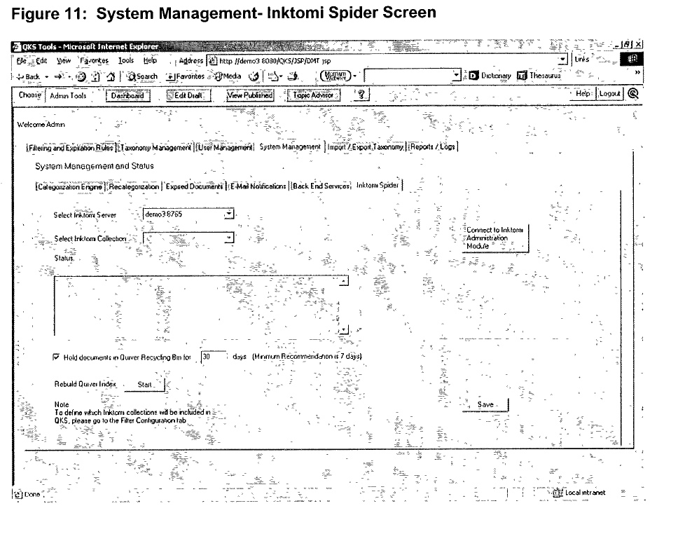

FIG. 11 illustrates an exemplary window displayed when spider option 170 of the system management window 200 is selected according to one embodiment. This window allows the user to view the search engine spider status by collection. For example, in one embodiment, a crawler such as an Inktomi Enterprise Search spider (available from Inktomi Inc., Foster City, Calif.) is used to identify and collect documents for processing. Such spiders are particularly useful for “crawling” through the internet collecting web pages and other documents as is well known. In embodiments using spiders, the user is also able to connect to an administration module, e.g., a Inktomi Search Administration module. Additional features provided in this window include the ability to define recycling bin holding time (related to Workflow Memory™ as will be discussed in more detail later), and to rebuild the search index in the case of corruption or accidental deletion.

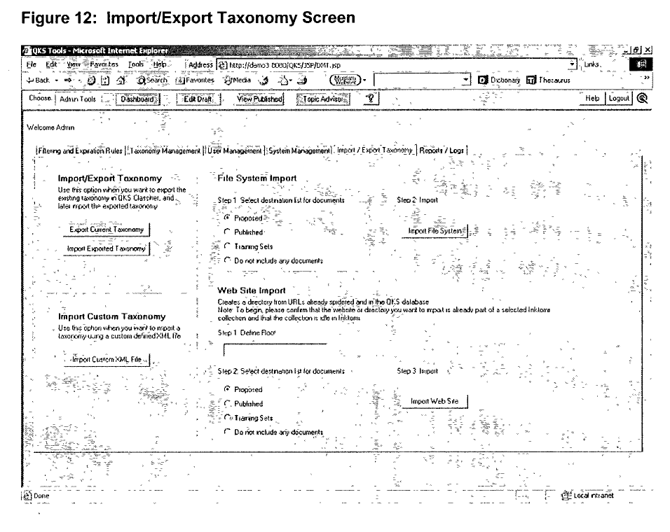

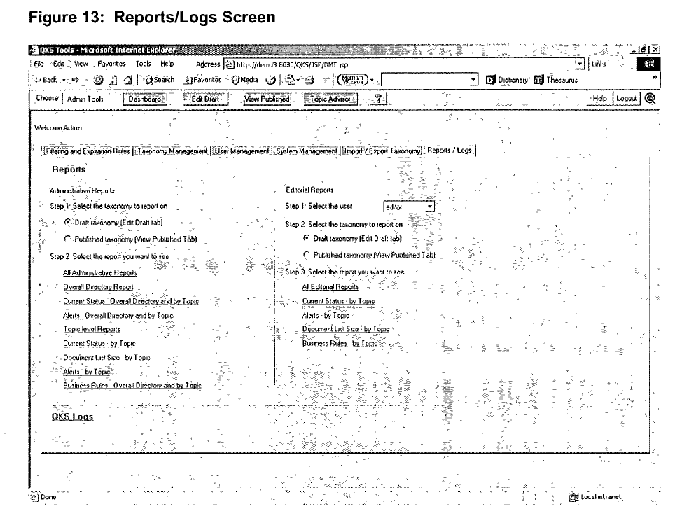

FIG. 12 illustrates an exemplary window displayed when import/export taxonomy option 135 of administrative tools window 110 is selected according to one embodiment. This window advantageously allows a user to perform many functions related to importing and exporting documents and files. For example, using this window, a user is able to export an existing taxonomy, documents and related data, and import various objects, files and documents, including for example, an exported file, a file system, a custom XML file (or any other markup language file), and a web site. The user can also select destination lists for placement of documents or document collections from imported files systems and web sites, e.g., proposed, published, training sets.

FIG. 13 illustrates an exemplary window displayed when reports/logs option 140 of administrative tools window 110 is selected according to one embodiment. This window advantageously allows a user to perform many reporting functions. For example, using this window, a user is able to run and view administration reports (e.g., alerts, document list sizes, etc.), run and view editorial reports, and connect to system logs.

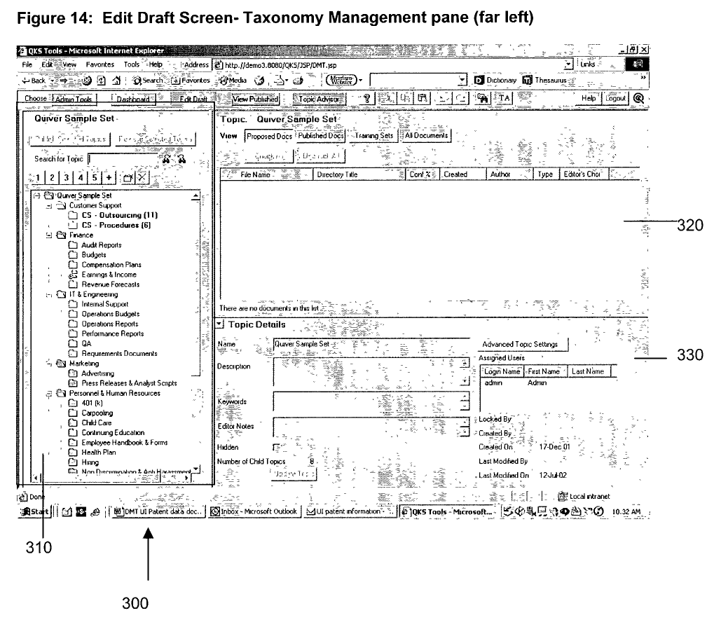

FIG. 14 illustrates an exemplary window 300 displayed when edit draft option 112 of window 100 is selected according to one embodiment. As shown window 300 includes a taxonomy management pane 310, an document list pane 320 and a topic details pane 330. Using taxonomy management pane 310, a user is advantageously able to perform topic management functions. For example, a user is preferably able to view an existing topic hierarchy (taxonomy) and its name (“Quiver Sample Set” as shown); identify topics assigned to the logged-in user (e.g., displayed as yellow folders); navigate through the topic tree (e.g., open and close hierarchy levels, search for topics); add, move, and delete new topics; rename topics; create topic shortcuts; view topics with documents in their Proposed lists, and identify how many documents are in the list (e.g., as shown, these topics appear in bold font and have a number in parentheses after them.); and resize the panes.

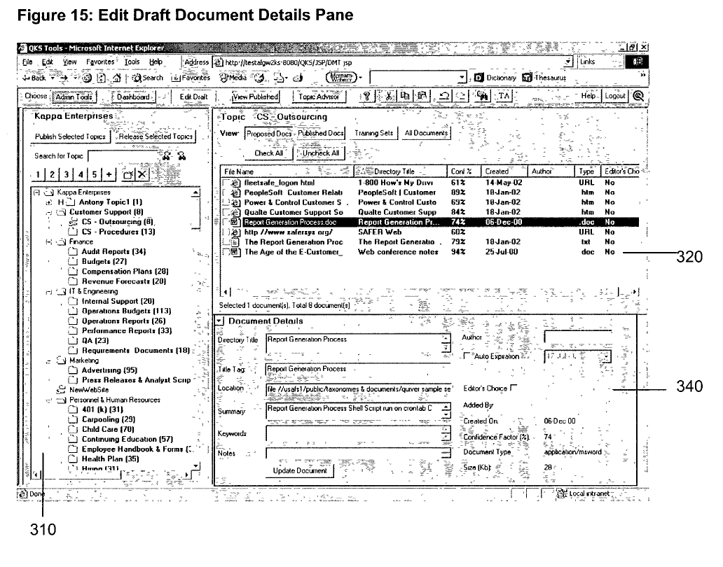

FIG. 15 illustrates another view of window 300 after a user has selected a document list from the taxonomy tree in pane 310. As shown the list of documents appears in pane 320 and document detail information (for a selected document) appears in document details pane 340. This window advantageously allows a user to view and edit document metadata, including, for example, name, document type, document size, author, description, document keywords, and editor's notes. The user is also preferably able to mark a document as “Editor's Choice” to present directory end-users with such marked documents above others in the topic regardless of confidence score, define a document-specific expiration date, view the date the document metadata was last updated, and by whom. Pane 340 can be fully closed, as well as resized.

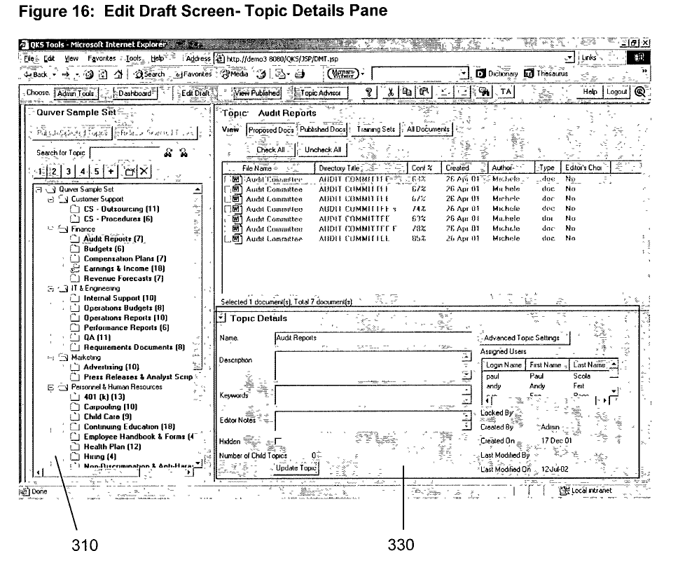

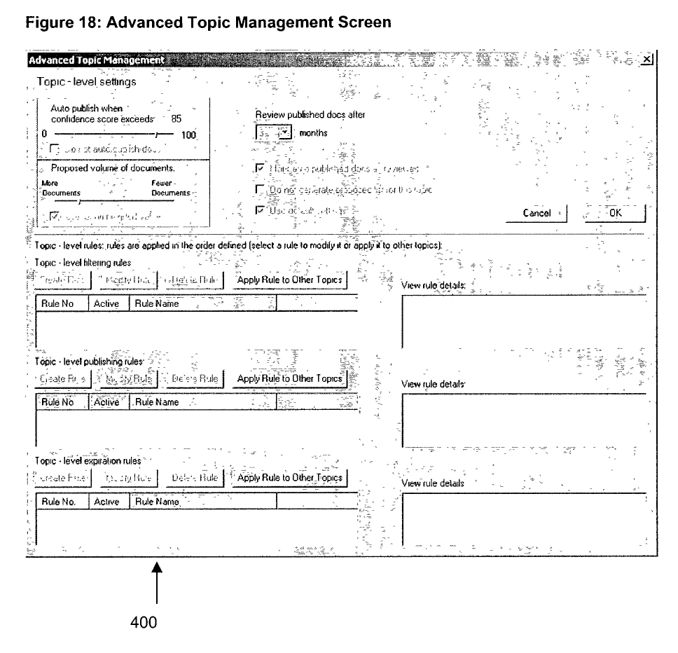

FIG. 16 illustrates another view of window 300 after a user has selected a document list from the taxonomy tree in pane 310. As shown the list of documents appears in pane 320 and topic detail information appears in topic details pane 330. Using this window, a user may advantageously view and edit topic metadata, such as topic name, description, topic keywords, editor's notes, number of child topics, etc. The user may also connect to Advanced Topic settings (see, e.g., FIG. 18 and discussion below), view others assigned to this topic, and mark a topic as hidden so it will not appear in the end user directory even if it has been published. Pane 330 can be resized, as well as fully closed.

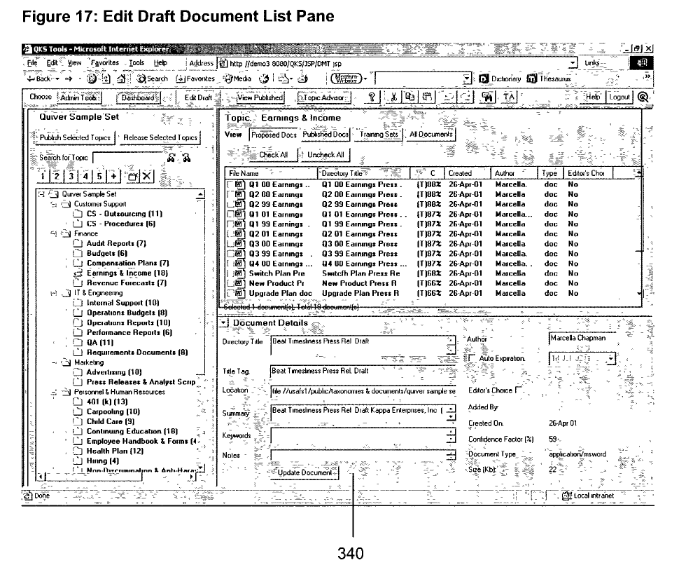

FIG. 17 illustrates another view of window 300 after a user has selected a document list from the taxonomy tree in pane 310, specifically “Earnings & Income” from within the “Finance” sub-topic. As shown the list of documents appears in pane 320 and document detail information (for a selected document) appears in document details pane 340. Using this window, a user is advantageously able to view all documents associated with a selected topic, by each list or all lists together. Also, a user can view metadata associated with each document, check documents for publishing, open documents (e.g., by double clicking on the document title), sort documents by any of the column fields (e.g., by clicking on the column header name), mark individual docs as “reviewed”, override document title (directory title), delete any document from any list, and insert new documents to any of the three lists (e.g., by cutting and pasting or dragging and dropping).

FIG. 18 illustrates an exemplary window 400 displayed when a user selects an Advanced Topic Settings Option (e.g., in pane 330 of window 300) according to one embodiment. Using this window, a user is advantageously able to perform topic management functions. Examples of such topic management functions include the ability to view and/or override auto-publishing settings; view and/or override algorithm precision/recall settings; view and define document review periods; define whether or not to allow documents to be associated with that topic; view, create, modify and delete topic-level publishing rules; view, create, modify and delete topic-level filtering rules; and view, create, modify and delete topic-level document expiration rules.

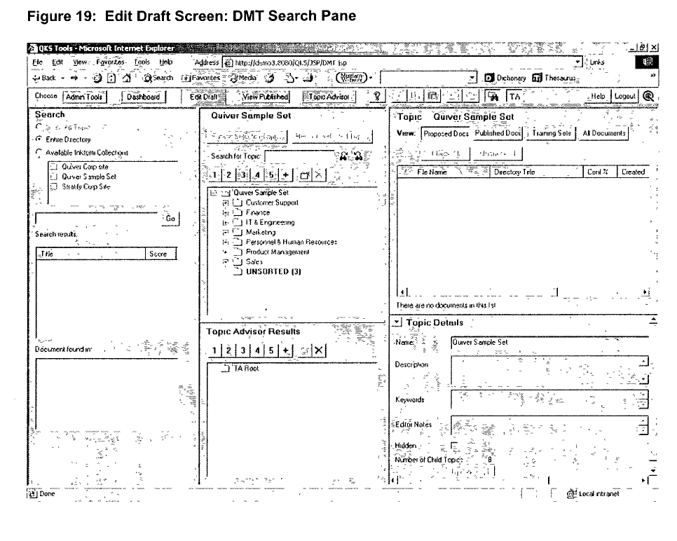

FIG. 19 illustrates an example of a search window displayed to the user, for example in response to a search selection from pane 310 of window 300. This window allows the user to search for documents in the taxonomy, search for documents in collections, such as in spider (e.g., Inktomi) collections, and drag and drop search results into a document list.

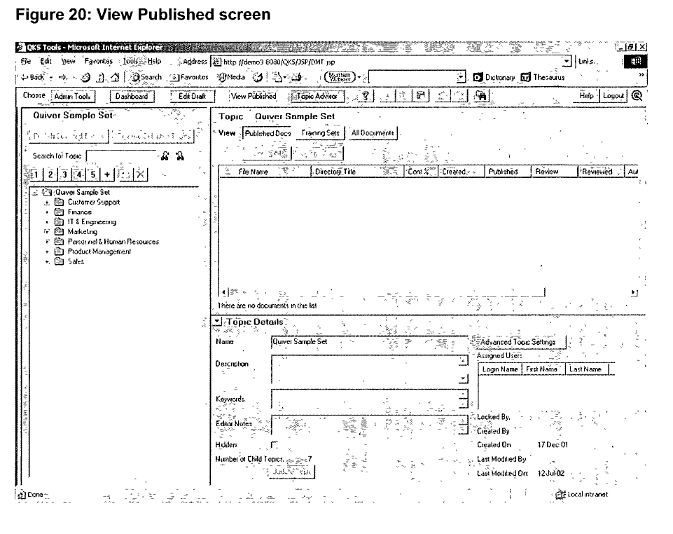

FIG. 20 illustrates an exemplary window displayed when view published option 113 of window 100 is selected according to one embodiment. This window allows the user to view published documents in the taxonomy. For example, the user may view documents published by topic, and view topic and document details by either selecting a topic or a document.

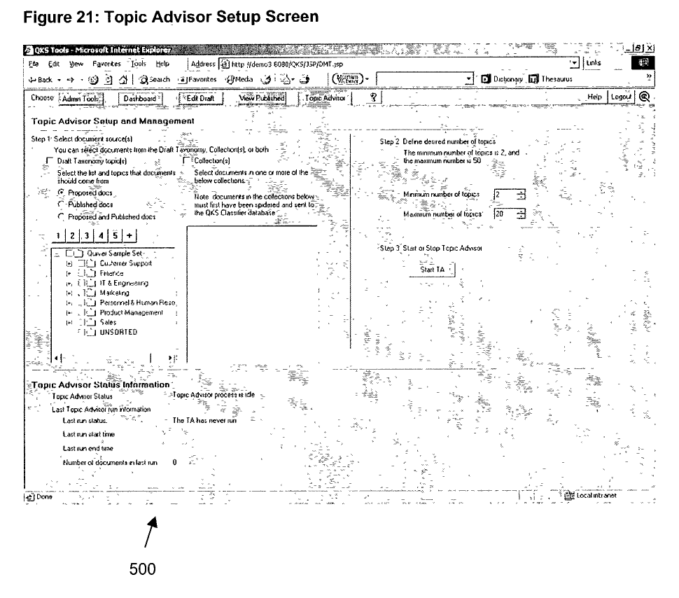

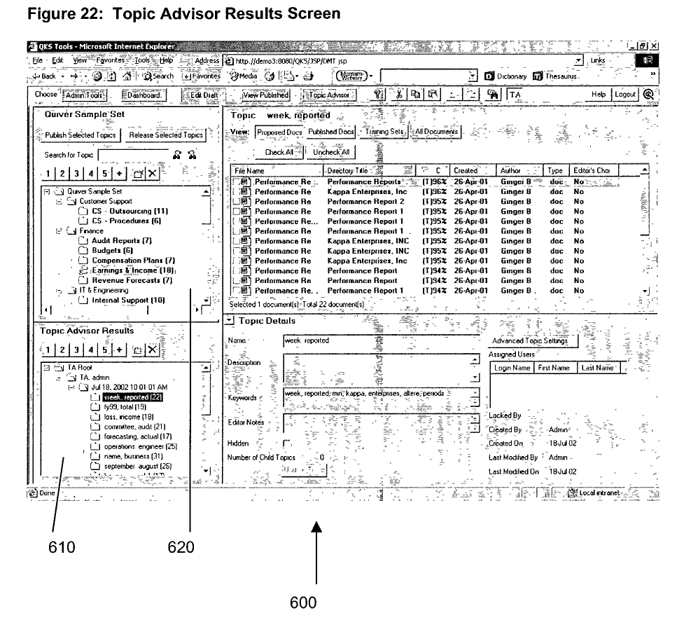

FIG. 21 illustrates an exemplary window 500 displayed when Topic Advisor option 114 of window 100 is selected according to one embodiment. As shown, startup window 500 allows a user to define a document corpus for one or more Topic Advisor algorithms to analyze. A Topic Advisor algorithm, which serves as a preliminary categorization tool, analyzes the content of the collection as a whole and/or individual documents, including metadata, and determines probable topics among all topics for placement of the documents. The user can also, for example, define a quantity (range) of desired topics, initiate and stop Topic Advisor runs, and view status of Topic Advisor. FIG. 22 illustrates an example of a Topic Advisor result window 600 displayed in response to a Topic Advisor run. In window 600, a user may view results from within an Edit Draft-type screen, view Topic Advisor run details. The user may also drag and drop results (e.g., topic suggestions) from a results pane 610 into a draft taxonomy pane 620, for editing. Preferably, the user may perform all tasks defined in the Edit Draft screen (see, e.g., FIGS. 14-17).

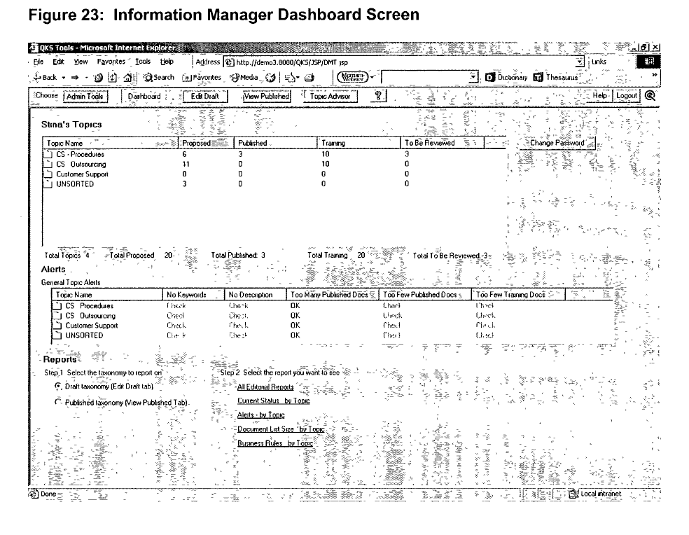

FIG. 23 illustrates an exemplary window displayed when Information Manager Dashboard option 111 of window 100 is selected according to one embodiment. Using this window, a user may, for example, view all topics assigned to the individual information manager who is logged in, view the number of documents in each document list, view all alerts per topic, change passwords, run reports, link from a topic in this view to the same topic in an Edit Draft screen, and receive a link to this screen via email if configured as such.

In one embodiment, a workflow memory management system 49 (FIG. 1) is provided to enable the categorization engine 40 to keep track of information manager actions upon specific documents, the taxonomy, or any content accessed in or by the system. Workflow memory management system 49 interfaces with memory 52 or other memory such as an external memory, and stores information and state of the content at the time of information manager action, as well as the result of that action. As content changes, or the taxonomy changes, it then compares this saved information to the current state of the content, and makes the determination whether additional editorial input is required based on the extent of the change in state. The workflow memory eliminates redundant work by comparing new work with recent information manager activity, anticipating and automatically performing redundant tasks for the information manager.

Workflow memory system 49 is preferably configured to keep all editorial decisions for each document within database 55. In addition, workflow memory system 49 includes various mechanisms that keep track of the state of the document at the time editorial operations were last performed on content. Topic and document information stored in the system is preferably configurable to include, for example:

Confidence scores assigned by the categorization engine for the proposed topic, as well as parent, sibling or child topics;

Multiple checksums, covering, for example, the text of an entire document and the first and last N characters of the document;

Metadata available for a document: for example, title(s), summary or description, location (URL), last modified date/time, author, content of custom metadata fields (may have corresponding external application information)

Threshold Value—A threshold determines the level of “small changes” in document contents, topic matching, or the taxonomy itself that would determine whether additional editorial review is required at this time. This reduces editorial involvement for minor changes in content or taxonomy, while still ensuring that significant changes are queued for appropriate action.

Recycle Bin—A flag placed on all deleted documents which are in fact kept for a configurable amount of time (e.g., 7 days minimum, 30 days default, 365 days maximum). After the time period has passed, the document will be removed from the system database permanently. This allows documents which are temporarily unavailable, renamed, or moved to a new location to be recognized, and the past editor action retaken automatically if changes do not exceed the “threshold”, minimizing re-work in such cases.

Example Workflow Memory Use Cases:

1. Document is Rejected by Information Manager

A document currently in the system is rejected by a user from any list in a topic (proposed, published or training). Workflow memory system 49 is invoked at time of delete action, saving information with regards to the delete action, e.g., state of document at that time and some or all meta-information. The document is later found again, e.g., by the spider, and passed to the Categorization Engine. Without Workflow memory management module 49, the document would be proposed again, and the information manager would have to repeat actions. With workflow memory management module 49 activated, however, the Categorization Engine checks workflow memory during processing of the document and finds saved information. The Categorization Engine then compares current state and meta-information of the document with the previously saved state and meta-information. If the difference exceeds the configured threshold(s) in the system, the document is re-proposed to topic(s) as it is deemed different enough to warrant editorial review. If, however, the changes do no exceed the configured threshold(s), the document is not placed in a topic by the Categorization Engine.

2. Document is Deleted at Source, Temporarily Unavailable, Renamed, or Moved

A document currently in the system is physically deleted at the source (e.g., website), or renamed, or moved to a new location. For example, the system is notified of document deletion by the search crawler, document is placed in Recycling Bin¹, document is removed from end user directory view and change in status is noted for Information Managers in Directory Management Tool. If the document is reinstated on original source directory, new source, or with new name, when the spider finds document, the spider sends an add document notification to the system (as with a new document). The “new” document submitted is compared to recycling bin. If a “match” is found the system will recognize document as same and reinstate to its previous location(s) within the system. Recycling Bin is a configurable status flag in the database. It determines length of time to retain a document before purging, allowing Workflow Memory to reinstate documents into the system without Information Manager intervention.

3. Document is Modified, or Appears to be Modified

A document currently in system is updated on source, or dynamic content change(s) occurs to document such as a real time stock price inserted into document is updated. The Categorization engine is notified of change in status of document. The new state and meta-information of the document is compared to previously saved document information by the Categorization Engine using the workflow memory management system. If the difference exceeds a configured threshold(s) in the system, the document is re-proposed to topic(s) as it is deemed different enough to warrant editorial review. If, however, the changes do not exceed the threshold(s), the document is not re-proposed, and additional state and meta-information changes are saved.

4. Taxonomy is Modified, or Appears to be Modified (e.g., Structure Change)

An Information Manager edits the taxonomy structure (i.e., adds topics, moves topics, deletes topics, modifies topics). The workflow memory system automatically re-queues content in affected topics for re-categorization immediately. Other content will be queued for re-categorization over time as well based on scheduled review date information. Content which is essentially unchanged (e.g., based on checksum info), and which scores within the threshold for a current topic, sibling topics, and/or parent topic, preferably has last editor action restored. Content which changes beyond threshold based on taxonomy modifications will be queued to appropriate topics for editorial review.

While the invention has been described byway of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method of classifying documents to one or more topics, comprising:
a) receiving a set of one or more documents;
b) automatically applying a classification algorithm to each document in the set of documents so as to associate each document with none, one or a plurality of said topics;
c) for each document-topic association:
automatically determining a confidence score; and
comparing the confidence score to a user-configurable threshold, wherein if the confidence score exceeds said threshold, associating the document with a first list for the topic, and wherein if the confidence score does not exceed the threshold, associating the document with a second list for the topic; and
d) for a selected topic, providing the second list of documents to a user for manual confirmation or re-classification.

2. The method of claim 1, wherein the classification algorithm includes a machine learning algorithm.

3. The method of claim 2, wherein the machine learning algorithm includes one of a Naïve Bayes algorithm, a Support Vector Machines algorithm, and a Decision Trees algorithm.

4. The method of claim 1, wherein the classification algorithm generates a raw score for each document-topic association.

5. The method of claim 4, wherein said confidence score is a function of the raw scores for the document across all topics.

6. The method of claim 4, wherein said confidence score is a function of the raw scores of a set of training documents.

7. The method of claim 4, wherein said confidence score is a function of the raw scores of all previous documents associated with the topic.

8. The method of claim 1, wherein said confidence score for each document-topic association is a function of:
the raw scores for the document across all topics;
the raw scores of a set of training documents; and
the raw scores of all previous documents associated with the topic.

9. The method of claim 1, further including:
displaying a graphical user interface, wherein said graphical user interface allows a user to selectively view, for each topic, documents in the first and second lists.

10. The method of claim 9, further including re-associating a document from the second list to the first list for a topic in response to an instruction received from a user.

11. The method of claim 1, further including:
storing classification information, checksum information and metadata associated with each document.

12. The method of claim 11, wherein said classification information includes raw scores and confidence scores for each document-topic association, and wherein metadata includes one or more of the following information fields: title, summary, description, document source, last modified date, last modified time, author, and content of custom metadata fields.

13. The method of claim 1, wherein said one or more topics are arranged in a user-configurable heirarchy structure, including parent, child and sibling topic nodes.

14. The method of claim 13, further including modifying the topic heirarchy structure in response to a user command, wherein one or more topics are affected, and thereafter automatically repeating steps b) and c) for each document associated with an affected topic.

15. A system for classifying documents to one or more topics, the system comprising:
a processor for executing a document categorization application, said categorization application including:
a communication module configured to receive a plurality of documents from one or more sources;
a classification module configured to automatically apply a classification algorithm to each document so as to associate each document with none, one or more of said topics; and
a ranking module configured to, for each document-topic association, automatically determine a confidence score and compare the confidence score to a user configurable threshold;
a data base memory configured to store two lists for each topic, wherein for each document-topic association, if the confidence score exceeds said threshold, the document is stored to a first list associated with the topic, and wherein if the confidence score does not exceed said threshold, the document is stored to a second list associated with the topic; and
a means for displaying the second list of documents for a selected topic to a user for manual confirmation or re-classification.

16. The system of claim 15, wherein the classification module includes a classification algorithm selected from the group consisting of a Naïve Bayes algorithm, a Support Vector Machines algorithm, and a Decision Trees algorithm.

17. The system of claim 15, wherein the classification module generates a raw score for each document-topic association.

18. The system of claim 17, wherein said confidence score is a function of the raw scores for the document across all topics.

19. The system of claim 17, wherein said confidence score is a function of the raw scores of a set of training documents.

20. The system of claim 17, wherein said confidence score is a function of the raw scores of all previous documents associated with the topic.

21. The system of claim 15, wherein said confidence score for each document-topic association is a function of:
the raw scores for the document across all topics;
the raw scores of a set of training documents; and
the raw scores of all previous documents associated with the topic.

22. The system of claim 15, wherein a document is re-associated from the second list to the first list for a topic in response to an instruction received from a user.

23. The method of claim 14, wherein modifying includes adding a topic to the hierarchy, and wherein steps b) and c) are repeated for all documents.

24. The method of claim 1, wherein each topic has associated therewith a set of user-configurable parameters, and wherein an association determined by the classification algorithm for each document is based on the topic's parameters.

25. The method of claim 24, wherein each parameter includes one of a keyword and metadata.

26. A computer-readable medium including computer code for controlling a processor to classify a document to one or more topics, the code including instructions to:
identify a set of one or more documents;
automatically apply a classification algorithm to each document in the set of documents so as to associate each document with none, one or a plurality of said topics;
for each document-topic association:
automatically determine a confidence score;
compare the confidence score to a user-configurable threshold; and
associate the document with a first list for the topic if the confidence score exceeds said threshold, and associate the document with a second list for the topic if the confidence score does not exceed the threshold; and
for a selected topic, render the second list of documents on a user display for manual confirmation or re-classification.

27. The computer-readable medium of claim 26, wherein the classification algorithm is selected from the group consisting of a Naïve Bayes algorithm, a Support Vector Machines algorithm, and a Decision Trees algorithm.

28. The computer-readable medium of claim 26, wherein the instructions to identify include instructions to activate a spidering search algorithm.

29. The method of claim 9, wherein the graphical user interface allows a user to modify and add metadata associated with a document.

30. The method of claim 9, further including re-positioning a first document in the first list in response to a user instruction, and storing in association with the first document, metadata related to the position of the first document in the first list.

31. The system of claim 15, wherein the categorization application further includes a memory management module that stores metadata associated with each document to the database memory.

32. The system of claim 31, wherein the memory management module stores modified metadata for a first document in response to a user instruction to modify or add additional metadata for the first document.

33. The system of claims 31, wherein a first document is re-positioned in the first list in response to a user instruction, and wherein metadata identifying the position of the first document in the first list is stored in association with the first document by the memory management module.

34. A document management system, comprising;
a database memory for storing documents and state information and metadata associated with the documents; and
a workflow management module configured to receive user modifications to the metadata associated with documents and to store the user modified metadata associated with the documents;
wherein if the state information of a first document changes or if the first document is removed from the system and later re-introduced to the system in a modified state, the workflow management module processes the first document according to the stored user-modified metadata.

35. The document management system of claim 34, wherein the workflow management module categorizes each document to one or more topics based either on the original metadata associated with the document if no user-modified metadata exists for the document, or on the user-modified metadata associated with the document.

36. The system of claim 34, wherein the metadata for a document includes metadata related to the one or more topics.

37. The system of claim 34, wherein the workflow management module processes the document by determining whether an amount of changes to the first document exceed a threshold, and if so queueing the document for review by a user.
